(19) United States
(12) Patent Application Publication
(10) Pub. No.: US 2009/0059285 A1
(43) Pub. Date: Mar. 5, 2009

(54) PRINTING SYSTEM, CONTROL METHOD, RECORDING MEDIUM, AND PRINTING APPARATUS

(75) Inventor: Masamichi Akashi, Funabashi-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/198,684

(22) Filed: Aug. 26, 2008

(30) Foreign Application Priority Data
Aug. 30, 2007 (JP) 2007-224556

(51) Int. Cl. G06F 3/12

(52) U.S. Cl. 358/1.15

(57) ABSTRACT

There is provided an arrangement that contributes to practical use of a product adapted to generate an instruction adapted to handle information relating to post- processing to be performed on printed material. Specifically, there is provided a printing system including a generation unit adapted to generate an instruction, and a controller adapted to control a printer to generate printed material without generating the instruction by the generation unit in a case wherein the instruction does not need to be generated. The controller is adapted to control the generation unit so as to generate the instruction along with the printed material being generated at the printer in a case in which there is a need to generate the instruction.

### BACKGROUND OF THE INVENTION

1. Field of the Invention

The present invention relates to a printing system, control method, recording medium, and printing apparatus adapted to generate an instruction adapted to handle information relating to post-processing to be performed on printed material.

2. Description of the Related Art

There has been studied regarding a POD printing system or the like enabling an instruction (also referred to as “job ticket”) in which information relating to post-processing thereof is described to be used in a case wherein printed material generated by a printing apparatus is subjected to post-processing. Note that heretofore, technology relating to a POD printing system has been proposed (e.g., see US Patent Application Publication No. 2004-01900057).

However, with the above-mentioned related art, there has been no proposal made dealing with a problem wherein an instruction is unnecessarily generated.

Also, with the related art, a problem may be caused wherein generation of an instruction is attempted although no instruction is needed, and as a result thereof, in a case wherein no instruction can be generated for any reason, for example, such that resources for generating an instruction are insufficient. However, with the related art, there has been no proposal dealing with a productivity problem wherein generation of printed material which should be performed originally is delayed since generation of an instruction is attempted improperly.

Also, with the related art, there has been no proposal dealing with a problem that can occur due to a cause wherein, even though an instruction is generated in response to the need for an instruction, an instruction is generated separately from generation of printed material. An example of this problem is a problem wherein an instruction different from an instruction that should be used originally is employed erroneously. Also, there is also a problem due to this cause wherein printed material is subjected to erroneous post-processing.

Thus, there is still much room for improvement to realize practical use of a product which enables an instruction to be generated.

### SUMMARY OF THE INVENTION

The present invention provides for an arrangement that contributes to practical use of a product adapted to generate an instruction adapted to handle information relating to post-processing to be performed on printed material.

To this end, according to an embodiment of the present invention, a printing system includes: a generation unit adapted to generate an instruction, with the instruction being adapted to handle (process) information relating to post-processing to be performed on printed material generated by a printer; and a controller adapted to control the printer to generate the printed material without generating the instruction by the generation unit in a case in which there is no need to generate the instruction; with the controller being adapted to control the generation unit so as to generate the instruction along with the printed material being generated at the printer in a case in which there is a need to generate the instruction.

Also, according to an embodiment of the present invention, a controlling method adapted to a printing system configured to cause a generation unit to generate an instruction, with the instruction being adapted to handle information relating post-processing to be performed on printed material to be generated by a printer, the method comprises: causing the printer to generate the printed material without generating the instruction by an instruction generating unit in a case in which there is no need to generate the instruction; and causing the instruction generating unit to generate the instruction by the printer generating the printed material in a case in which there is a need to generate the instruction.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principle of the invention.

FIG. 1 is a diagram illustrating the configuration of an entire POD printing system including a printing system.

FIG. 2 is a block diagram illustrating the configuration of an image forming apparatus which serves as a printing system.

FIG. 3 is a diagram illustrating a user interface screen.

FIG. 4 is a diagram illustrating a user interface screen.

FIG. 5 is a diagram illustrating an example of an instruction.

FIG. 6 is a flowchart illustrating a specific example of control relating to generation of an instruction.

FIG. 7 is a diagram illustrating a user interface screen.

FIG. 8 is a diagram illustrating a user interface screen.

FIG. 9 is a flowchart illustrating a specific example of control relating to generation of an instruction.

FIG. 10 is a diagram illustrating a user interface screen.

FIG. 11 is a flowchart illustrating a specific example of control relating to generation of an instruction.

FIG. 12 is a diagram illustrating a user interface screen.

FIG. 13 is a flowchart illustrating a specific example of control relating to generation of an instruction.

FIG. 14 is a flowchart illustrating a specific example of control relating to generation of an instruction.

FIG. 15 is a diagram illustrating an example of an instruction.

### DESCRIPTION OF THE EMBODIMENTS

An embodiment of the present invention will be described below in detail with reference to the drawings.

Note that with the following description, a device called a finisher serving as a post-processing apparatus for subjecting printed material to post-processing is employed. This device can be classified into three types.

A post-processing apparatus classified into the first type is configured so as to physically connect to a printing apparatus (e.g., image forming apparatus 102 of the present type). This type of post-processing apparatus is configured so as to directly supply sheets printed at the printing apparatus to a post-processing unit within the apparatus through a conveyor path within the printing apparatus without intervention such as an operator conveying the sheets. This type of post-processing is called an “inline finisher”. Note that this inline finisher is configured such that printed material can be subjected to post-processing set by an operator through the user interface of the printing apparatus.

A post-processing apparatus classified into the second type is connected to a network, and configured so as to perform data communication with another device. Note however, the type of the post-processing apparatus is not connected to the printing apparatus physically, and in order to subject printed material to post-processing at this apparatus, there is a need to set sheets printed at the printing apparatus to the post-processing apparatus thereof through manual labor of the operator. Note that this type of post processing apparatus is configured so as to interpret electronic data determining the content of instructions of the post-processing described in a later-described instruction, and so as to subject printed material to the post-processing determined with the data thereof. This type of post-processing apparatus is called an “nearline finisher”.

A post-processing apparatus classified into the third type is not connected to a network, and includes no data communication unit as to another device. This post-processing apparatus is not connected to the printing apparatus physically. In the case of subjecting printed material to post-processing at this type of post-processing apparatus, there is a need to set sheets printed at the printing apparatus to the post-processing apparatus thereof through the manual labor of the operator, and the operator needs to instruct post-processing to be executed through an operating unit included in the apparatus thereof. This type of post-processing apparatus is called an “offline finisher”.

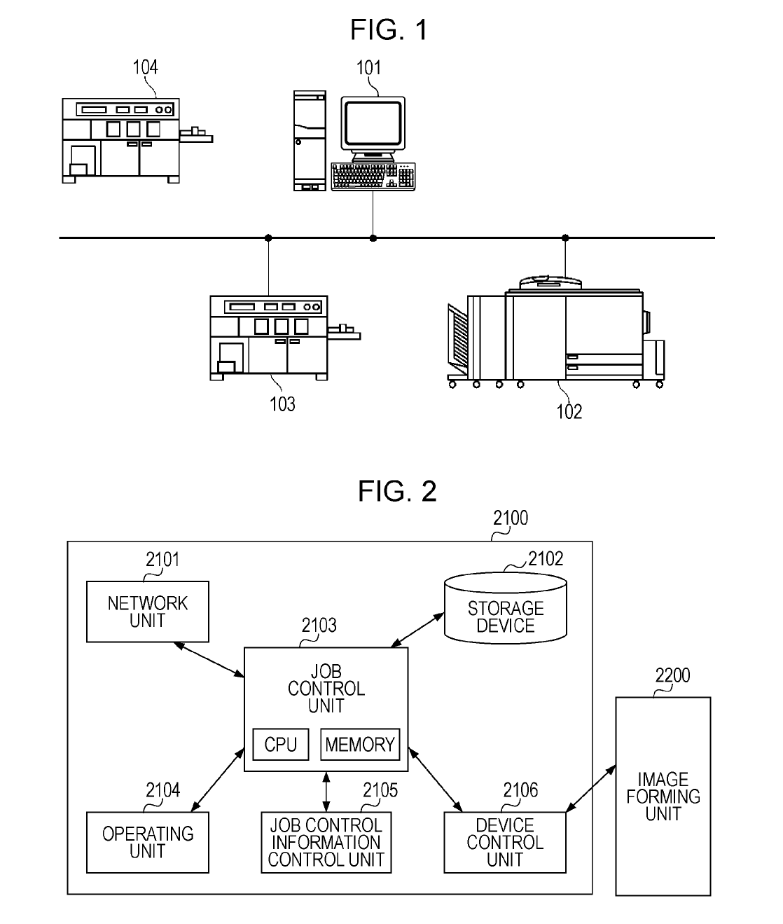

FIG. 1 is a block diagram illustrating the configuration of a POD printing system according to a first embodiment of the present invention. This POD printing system includes a client PC 101, image forming apparatus (also referred to as printer through printing apparatus) 102, nearline finisher 103 connected to a network, and offline finisher 104 not connected to the network.

Note that with the present embodiment, the image forming apparatus 102 serves as a printing system according to the present invention, and connected to an unshown inline finisher. This inline finisher has a configuration equivalent to printed material acceptance unit such as a sheet conveyance path, processing tray, and so forth for accepting printed material generated at the image forming apparatus 102 without intervention of the operator. With the present embodiment, printed material generated at the image forming apparatus 102 can also be subjected to desired post-processing using this inline finisher.

FIG. 2 is a detailed block diagram of the image forming apparatus 102. The image forming apparatus 102 serving as a printing system with the present embodiment includes an image forming unit (hereafter, printer unit) 2200 serving as a printer unit, unshown inline finisher, and a controller 2100 for controlling these. Also, the controller 2100 is configured of a network unit 2101, storage device 2102, job control unit 2103, operating unit 2104, job control information control unit 2105, device control unit 2106, and so forth.

Note that with the present embodiment, the controller 2100 serves as a control unit, and various types of control for the printing system according to the present embodiment are executed by the controller 2100. For example, the controller 2100 accepts a printed material generation request for a job to be processed, and controls the printer unit 2200 to generate printed material (equivalent to body according to later description) for this job. Thus, the controller 2100 handles necessary printing control for generating printed material to be subjected to post-processing at any of the above-mentioned three types of finishers.

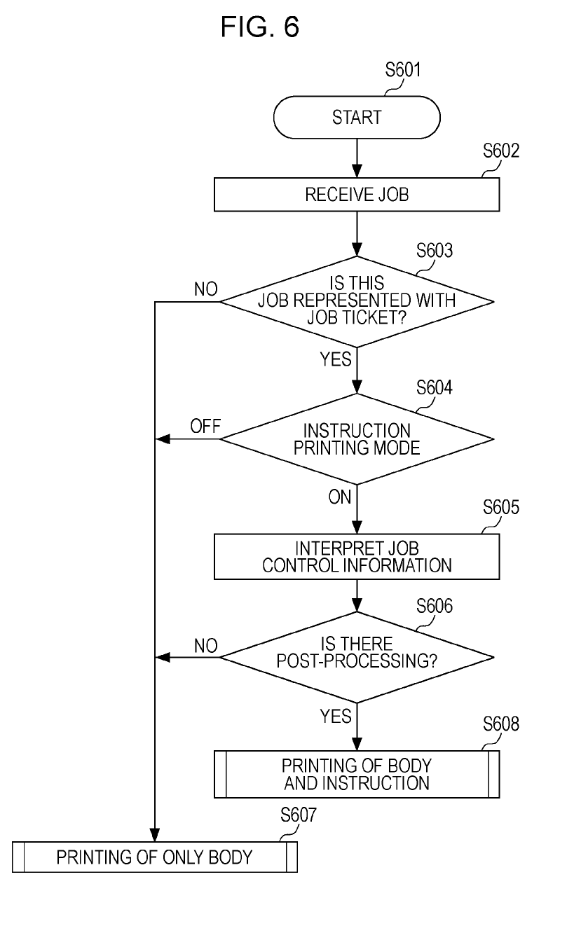

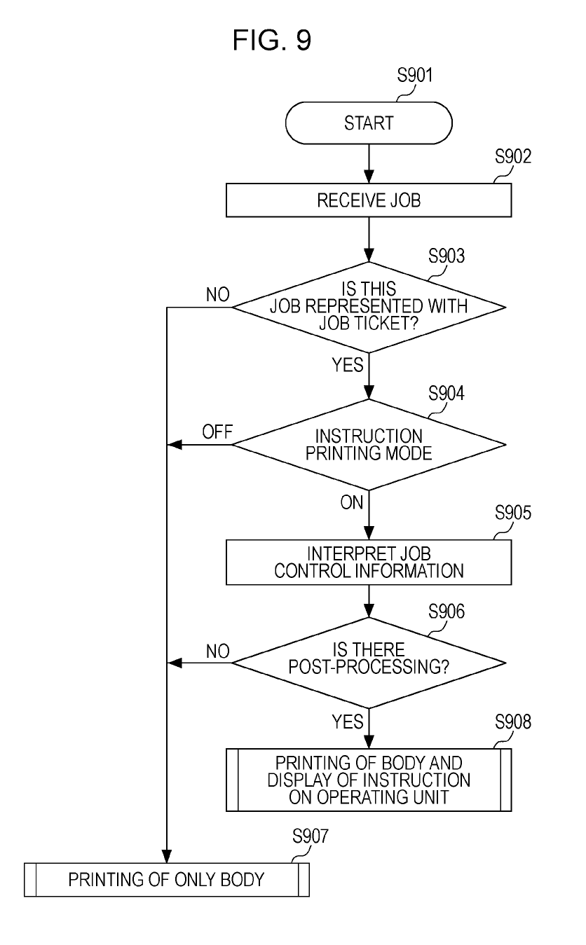

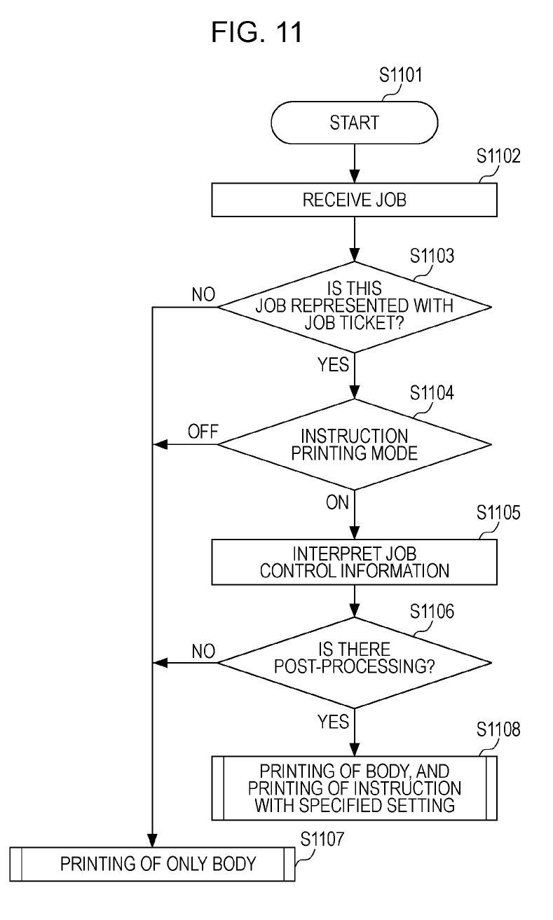

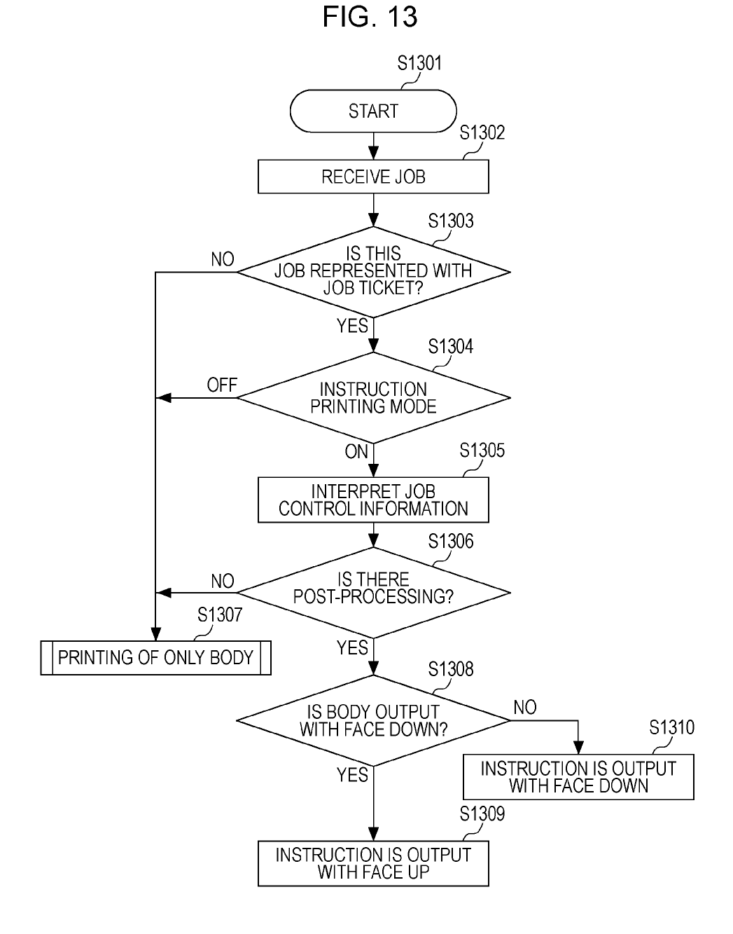

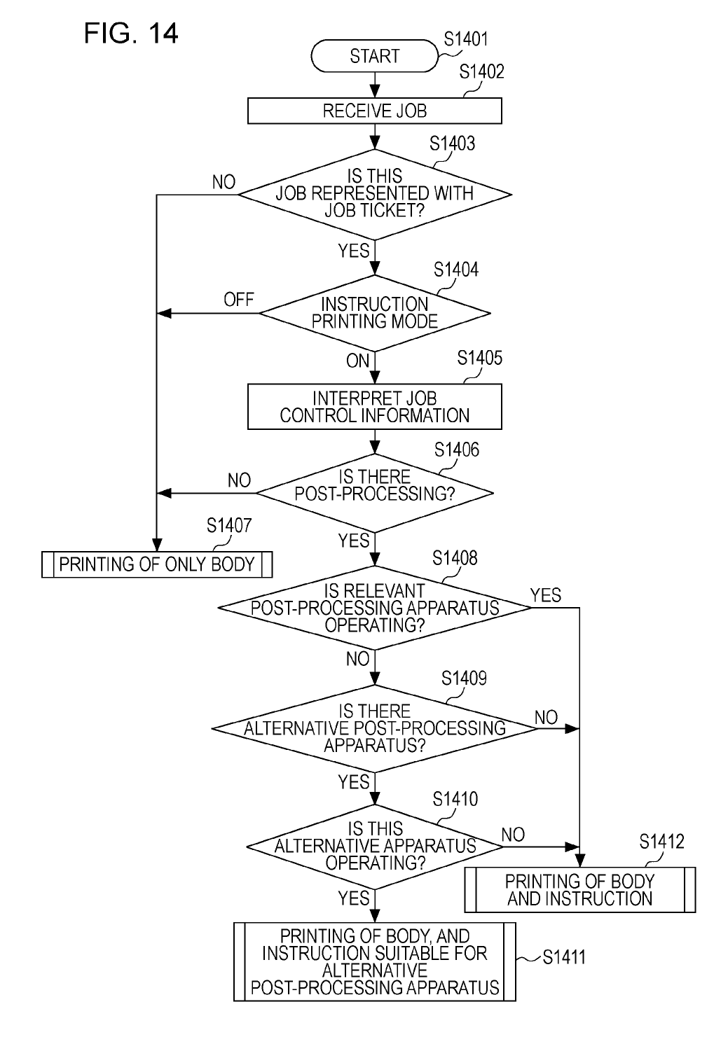

Also, the controller 2100 serving as this control unit also serves as a determining unit for determining whether or not there is a need to generate an instruction in which information relating to post-processing to be performed on printed material to be generated by the printer unit 2200. Determinations in later-described steps S603, S604, and S606 shown in FIG. 6, steps S903, S904, and S906 FIG. 9, steps S1103, S1104, and S1106 in FIG. 11, steps S1303, S1304, and S1306 in FIG. 13, and steps S1403, S1404, S1406, and S1408 through S1410 in FIG. 14, are all specific examples of this.

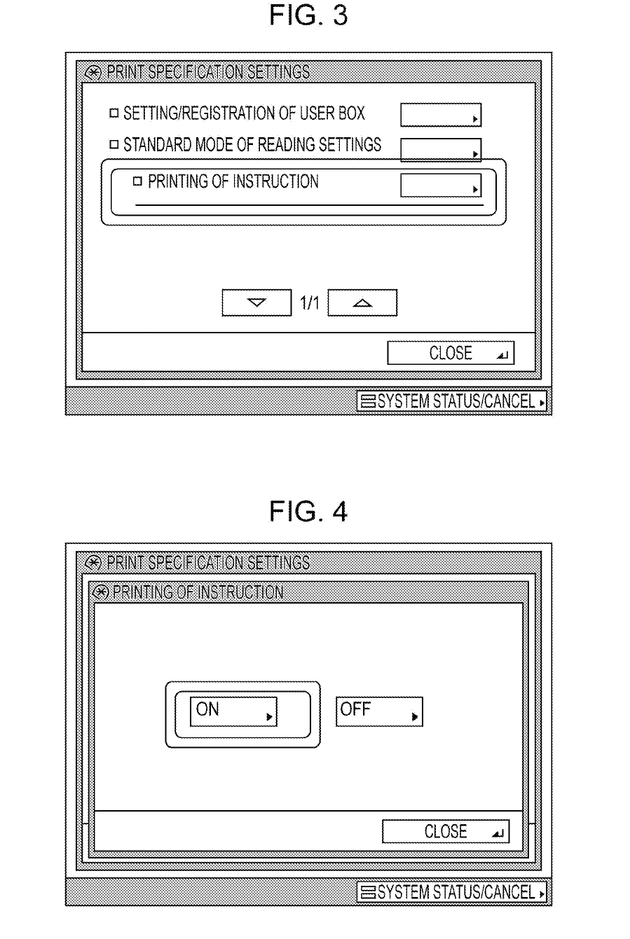

Note that the printing system according to the present embodiment includes a unit serving as a reception unit for accepting instruction necessity determination material data necessary for determining whether there is a need to generate an instruction. For example, with the present embodiment, the operating unit 2104 serves as an example of this reception unit. Also, an external data interface is also an example serving as this unit, such as the network unit 2101 or the like necessary at the time of accepting a printing job externally in later-described steps S602 shown in FIG. 6, S902 shown in FIG. 9, S1102 shown in FIG. 11, S1302 shown in FIG. 13, S1402 shown in FIG. 14, and so forth. Also, later-described user interface screens shown in FIGS. 3, 4, and 7 are specific examples of this user interface.

Now, let us say that the controller 2100 has determined that there is no need to generate an instruction for printed material to be generated at the printer unit 2200 (generation of an instruction is unnecessary). In this case, the controller 2100 performs control so as to generate printed material by the printer unit 2200 without generating an instruction by an instruction generating unit. Note that with a later-described specific example, user interfaces including a display function such as the printer unit 2200 or operating unit 2104 exemplify arrangements serving as this instruction generating unit. Also, any arrangement wherein the processing proceeds to later-described processing in steps S607 shown in FIG. 6, S907 shown in FIG. 9, S1107 shown in FIG. 11, S1307 shown in FIG. 13, or S1407 shown in FIG. 14, where body alone is generated, is a specific example of this control.

On the other hand of this control, let us say that the controller 2100 has determined that there is a need to generate an instruction for printed material to be generated at the printer unit 2200 (generation of an instruction is necessary). In this case, the controller 2100 performs control such that the instruction generating unit can generate an instruction in which information relating to post-processing to be performed on the printed material thereof along with generation of printed material by the printer unit 2200 is described. Any arrangement in which the processing proceeds to later-described processing in steps S608 shown in FIG. 6, S908 shown in FIG. 9, S1108 shown in FIG. 11, S1309 or S1310 shown in FIG. 13, or S1411 or S1412 shown in FIG. 14, where an instruction is also generated along with generation of body, is a specific example of this control.

Thus, with the present embodiment, the controller 2100 also serves as an instruction generating control unit for controlling generation of an instruction for describing information relating to post-processing as to printed material performed by any of the above-mentioned three types of finishers.

Thus, according to the printing system according to the present embodiment, there can be provided an arrangement dealing with a problem wherein an instruction is generated unnecessarily. Also, for example, there can be provided an arrangement dealing with a productivity problem wherein generation of printed material which should be performed originally is delayed since generation of an instruction is attempted improperly. Also, for example, there can be provided an arrangement dealing with a problem that can occur due to a cause wherein an instruction is generated separately from generation of printed material. Thus, the printing system according to the present embodiment enables an arrangement to be provided which contributes practical use of a product which enables an instruction to be generated.

Also, the controller 2100 serving as this control unit awaits until the printer unit 2200 completes generation of printed material of a job to be processed, and controls the instruction generating unit to generate the instruction. In order to perform this control, the controller 2100 monitors the generation status of printed material of a job requiring generation of an instruction based on the information from the printer unit 2200. This arrangement can prevent a trouble from occurring wherein an instruction is generated although printed material is not generated properly. Also, this arrangement can prevent a problem from occurring wherein the above-mentioned trouble occurs due to a cause by such a trouble. The printing system according to the present embodiment is configured so as to receive such an advantage.

Also, the printing system according to the present embodiment is configured such that the operator can perform setting for instructing generation of an instruction as to the image forming apparatus 102 through the user interface beforehand. With the present embodiment, the operating unit 2104 is employed as this user interface. Subsequently, in the case of determining that this setting has been performed beforehand, the controller 2100 performs control such that the above-mentioned instruction generating unit can generate an instruction in which information relating to post-processing to be performed on the printed material thereof is described along with generation of printed material by the printer unit 2200.

Also, while including the above-mentioned arrangement, the printing system according to the present embodiment is configured such that the operator can also perform setting for instructing generation of an instruction as to a job requiring generation of printed material by the printer unit 2200 through the user interface. Subsequently, let us say that the setting of the operator for instructing generation of an instruction as to a job requiring generation of printed material has been performed. In response to determination being made that the setting has been performed beforehand, the controller 2100 controls the above-mentioned instruction generating unit to generate an instruction for the job along with generation of printed material of the job by the printer unit 2200.

Note that with the present embodiment, in order for the controller 2100 to perform control relating to generation of an instruction, the operating unit 2104 has been exemplified as the user interface to be provided to the operator, but the present invention is not restricted to this. For example, there can be employed as this user interface an operating unit such as a monitor, pointing device, and so forth included by the PC 101 equivalent to an example of other devices capable of data communication with the image forming apparatus 102 through a network. In this case, the CPU of the other device performs control such that a display unit of the other device can display the user interface screens such as later-described FIGS. 3, 4, and 7. Thus, the above-mentioned instruction necessity determination material data can be accepted using the user interface of the other device, and an arrangement corresponding to later-described various types of arrangement can be realized at the other device. The printing system according to the present embodiment can be applied to such an arrangement as well.

Also, with the present embodiment, the network unit 2101 is configured so as to accept a particular type of job of which the content of instructions relating to printing processing and post-processing is defined with a particular file format as a printing job input from an information processing device such as the PC 101 or the like. Note that the printing system according to the present embodiment is configured so as to accept a job of which the content of instructions relating to printing processing and post-processing is not defined with this particular file format through an original reading unit (not shown) of the network unit 2101 and/or image forming apparatus 102. Now, let us say that a job requiring generation of printed material by the printer unit 2200 is this particular type of job. In the case of determination equivalent to this being made, the controller 2100 performs control such that the above- mentioned instruction generating unit can generate an instruction for the job along with generation of printed material of the job thereof by the printer unit 2200.

On the other hand, let us say that a job requiring generation of printed material by the printer unit 2200 does not correspond to this particular type of job. In the case of determination equivalent to this being made, the controller 2100 performs control such that the printer unit 2200 can generate printed material of the job without generating an instruction for the job thereof by the above-mentioned instruction generating unit. Any of arrangements based on later-described determination in steps S903 shown in FIG. 9, S1103 shown in FIG. 11, S1303 shown in FIG. 13, S1403 shown in FIG. 14, and so forth is a specific example of this control.

Note that with the present embodiment, a job of which the content of instructions is defined with this particular file format means a JDF job. JDF is an abbreviation of Job Definition Format, and is a format defined by CIP4, which is a common digital format relating to the entire printing process applicable to a POD printing system such as shown in FIG. 1. CIP4 is an abbreviation of International Cooperation for the Integration of Processes in Prepress, Press and Postpress.

On the other hand, a job of the content of instructions is not defined with this particular file format means a printing job having a different type from a JDF job (non-JDF job). For example, a PDL (Page Description Language) job to be transmitted from an information processing device such as the PC 101 or the like is an example of a non-JDF job. Also, a copy job wherein printing data to be subjected to printing processing is input from the above-mentioned reading unit or the like is an example of a non-JDF job.

With the format of JDF, XML language applicable to as a web format is employed. Equipment is configured so as to process a job having a JDF format like the image forming apparatus 102 according to the present embodiment, whereby management relating to the entire printing process can be performed such as production management, and confirmation of running status of each device such as a printing machine, and post-processing apparatus, and so forth, can be performed from a Web site.

This JDF job can define the content of instructions relating to a series of working processes to be performed by multiple types of devices being collaborated without being restricted to processing relating to one device, such as from an original reception process of printed data to a delivery process of printed material which are necessary for generating printed material as a final product. A JDF job is arranged so as to be accepted as a printing job like the image forming apparatus 102 according to the present embodiment, whereby a series of workflow management made up of multiple processes can be performed. Also, this can contribute to collaboration between multiple devices relating to the entire printing process, and automation of various types of devices.

Under such a background, with the present embodiment, the printing system according to the present embodiment is configured so as to exhibit convenience as a printing system not only for the office environment but also for the POD market, and also so as to perform control utilizing the characteristics of a JDF job as described above.

For example, the image forming apparatus 102 according to the present embodiment includes a JDF job acceptance unit for accepting a JDF job corresponding to a particular type of printing job employing XML language equivalent to this particular type of markup language. Also, the image forming apparatus 102 according to the present embodiment includes a JDF analyzing unit for analyzing various types of information defined with XML language of the accepted JDF job. These configurations are an example of an arrangement for realizing control utilizing the above-mentioned characteristics specific to JDF.

Note that with the present embodiment, the controller 2100 serves as the JDF job acceptance unit and JDF job analyzing unit, but the internal configuration of the apparatus according to these is not restricted to a particular configuration, and various modifications and applications can be made. For example, the network unit 2101 shown in FIG. 2 serves as the JDF job acceptance unit, and the job control information control unit 2105 serves as the JDF job analyzing unit for interpreting information defined with a JDF job. The CPU of the job control unit 2103 serves as a control unit. Thus, the present invention can be applied to any kind of internal configuration as long as the printing system through printing apparatus includes units for realizing various types of arrangements described with the present embodiment.

Also, with the present embodiment, information indicating the content of specific instructions such as post-processing or the as defined with a JDF job to be accepted by the image forming apparatus 102 can be interpreted not only by the image forming apparatus 102 but also by the PC 101, nearline finisher 103, and so forth. Thus, information not dependent on a particular type of device is packaged in a JDF job to be analyzed by the image forming apparatus 102. For example, the content described with XML language corresponding to one of markup languages to be packaged in a JDF job is interpreted, whereby various types of information can be confirmed mutually by various types of devices. Also, the PC 101 and nearline finisher 103 can perform data communication with the image forming apparatus 102 through a network.

Thus, various types of devices included in the POD printing system shown in FIG. 1 can be configured so as to mutually transmit/receive information relating to post-processing described in an instruction generated by the above-mentioned instruction generating unit through a transmitting unit such as described above by using the characteristics of JDF.

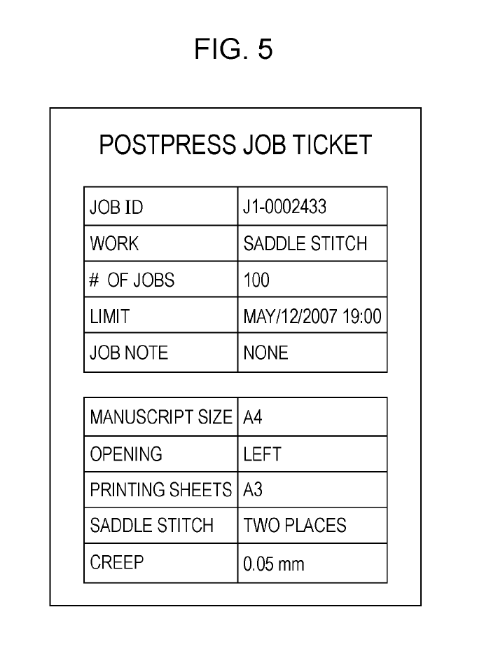

Also, as with the instruction shown in FIG. 5, the printing system according to the present embodiment is configured so as to describe information relating to post-processing to be performed on printed material generated at the printer unit 2200 in an instruction with an output form which can be visually interpreted by a human (operator).

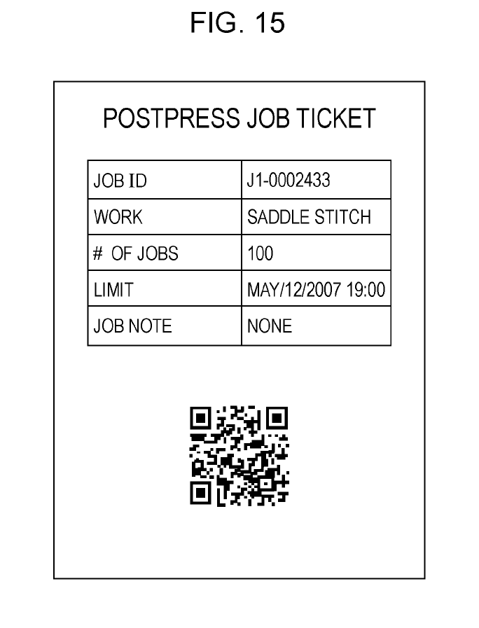

Further, the printing system according to the present embodiment is configured so as to generate an instruction such as shown in FIG. 15. That is to say, as with a QR code which is an example of a two-dimensional bar code described in the instruction shown in FIG. 15, the printing system according to the present embodiment is configured so as to describe information relating to post-processing to be performed on printed material generated at the printer unit 2200 in an instruction with an output form which can be interpreted by a machine.

Note that the nearline finisher 103 and offline finisher 104 shown in FIG. 1 include a bar-code reader (not shown) serving as an information reading unit which can read the two-dimensional bar code described in the instruction shown in FIG. 15. These devices can read the two-dimensional bar code of the instruction shown in FIG. 15 using this reading unit. Subsequently, these devices determine the type of post-processing to be performed on printed material generated at the printer unit 2200 along with generation of this instruction based on the read result. Subsequently, upon determining the type thereof, these devices can operate so as to subject the printed material thereof to the post-processing thereof. It is desirable to include such an arrangement, but the present invention is not restricted to this.

Also, as with the instruction shown in FIG. 15 which can be generated at the printing system according to the present embodiment, it is desirable to describe information relating to the above-mentioned post-processing not only with an output form which can be recognized by a human, but also with an output form which can be interpreted by a machine in the same output medium as one instruction. However, an arrangement may be employed wherein an instruction can be generated only with a form such as shown in FIG. 5. Also, an arrangement may be employed wherein the information of the post-processing can be output in an instruction only with a device (computer)-readable form.

Note that the printing system according to the present embodiment is configured so as to select the output form of information relating to post-processing described in an instruction from multiple selection candidates by the operator. For example, the controller 2100 controls the above-mentioned user interface to display a user interface screen including three types of choices.

The three choices are: the first choice corresponding to instructions for describing the information in an instruction with an output form which can be interpreted only by a human; the second choice corresponding to instructions for describing the information in an instruction with an output form which can be interpreted only by a machine; and the third choice corresponding to instructions for describing the information in an instruction with an output form which can be interpreted by both of a human and machine. Subsequently, the controller 2100 controls the above-mentioned instruction generating unit to describe information relating to the post-processing in an instruction with the output form corresponding to the selected choice by the operator on this screen. As with the printing system according to the present embodiment, it is desirable to include such an arrangement, but the present invention is not restricted to this.

Also, with the present embodiment, the controller 2100 determines whether or not a job requiring generation of printed material by the printer unit 2200 is a job requiring post-processing by the post-processing apparatus including a printed material acceptance unit for accepting the printed material without intervention of the operator. The above-mentioned inline finisher embedding a sheet conveyance path and processing tray for introducing printed material conveyed internally from the printer unit 2200 is a specific example of the post-processing apparatus. Thus, let us say that determination is made that a job to be processed is a job requiring post-processing by the inline finisher (inline finisher job). In this case, the controller 2100 controls the printer unit 2200 to generate the printed material of the job without generating an instruction for the job by the above-mentioned instruction generating unit.

This inline finisher job is a job not requiring material handling operation of the printed material by the operator before the printed material generated by the printer unit 2200 is subjected to post-processing. Thus, let us say that a job requiring generation of printed material by the printer unit 2200 is a job not requiring material handling operation of the printed material by the operator before the printed material is subjected to post-processing. With the present embodiment, in the case of this determination being made, the controller 2100 performs control so as to prevent the above-mentioned instruction generating unit from generating an instruction for the job along with generation of printed material of the job.

On the other hand, a job for subjecting printed material generated by the printer unit 2200 to post-processing by the offline finisher 104 or nearline finisher 103 is a job requiring material handling operation of the printed material by the operator before the printed material is subjected to post-processing. Now, let us say that a job requiring generation of printed material by the printer unit 2200 is a job requiring material handling operation of the printed material by the operator before the printed material is subjected to post-processing. With the present embodiment, in the case of this determination being made, the controller 2100 performs control so as to generate an instruction for the job by the above-mentioned instruction generating unit along with generation of printed material of the job.

Note that a job requiring subjecting printed material generated by the printer unit 2200 to post-processing by the offline finisher 104 is called an offline finisher job. Also, a job necessary for subjecting printed material generated by the printer unit 2200 to post-processing by the nearline finisher 103 is called a nearline finisher job. These jobs are jobs having a different type from the above-mentioned inline finisher job.

With the present embodiment, the nearline finisher job is an example of a job requiring post-processing by the post-processing apparatus excluding a printed material acceptance unit for accepting printed material generated by a printing unit without intervention by the operator, but including a communication unit for performing data communication with another device. Now, let us say that as with this nearline finisher job, a job requiring generation of printed material by the printer unit 2200 is a job requiring post-processing by the post-processing apparatus having such a configuration. In the case of determination equivalent to this being made, the controller 2100 performs control such that the operator can select through the above-mentioned user interface whether or not an instruction for the job is generated by the above-mentioned instruction generating unit along with generation of printed material of the job thereof.

This control can handle a case wherein the nearline finisher 103 is instructed on the content of post-processing through the network shown in FIG. 1, so the image forming unit 102 does not need to generate an instruction. In this case, the operator instructs the controller 2100 through the user interface on the effect that the job does not need to generate an instruction. In response to this, the controller 2100 performs control such that printed material is generated by the printer unit 2200 with the job, but an instruction for the job is not generated by the above-mentioned instruction generating unit. Thus, a problem can be suppressed wherein an instruction is unnecessarily generated against the will of the operator, whereby the above-mentioned advantage can be further improved. Thus, the printing system according to the present embodiment includes an arrangement taking the nearline finisher and JDF into consideration, whereby such an advantage can be obtained.

Note that with the present embodiment, in response to a job to be processed being an inline finisher job, the controller 2100 prohibits generation of an instruction of the job along with generation of printed material of the job. On the other hand thereof, in response to a job to be processed being an offline finisher job, the controller 2100 permits generation of an instruction of the job along with generation of printed material of the job. Further, on the other hand, in response to a job to be processed being a nearline finisher job, the controller 2100 performs control such that the operator can select through the user interface whether to generate an instruction of the job along with generation of printed material of the job. In order to improve the above-mentioned advantage, as with the printing system according to the present embodiment, it is desirable to have such an arrangement, but the present invention is not restricted to this.

Note that with the present embodiment, in the case of changing the post-processing apparatus for performing post-processing on printed material to be generated by the printer unit 2200, the controller 2100 controls such that the above-mentioned instruction generating unit can generate an instruction in which information to which the content of change thereof is reflected is described. Thus, a change request of the operator, such that an instruction needs to be generated, but another post-processing separate from the post-processing apparatus scheduled at the beginning needs to be employed, can be handled flexibly and suitably. An arrangement relating to later-described S1411 shown in FIG. 14 is a specific example of this control.

Also, as described with reference to FIG. 5, in the case of generating an instruction, control is performed as follows. The controller 2100 performs control such that the above-mentioned instruction generating unit can generate an instruction in which information which the operator can view is described as information relating to post-processing to be performed on printed material to be generated by the printer unit 2200.

Also, as described with reference to FIG. 15, the controller 2100 performs control such that the instruction generating unit can also generate an instruction in which information which a device necessary for performing the post-processing thereof can interpret is described. Note that with the above description, as the specific examples of this device the offline finisher 104 and nearline finisher 103 having a bar-code reader which can read a QR code have been exemplified, but devices other than these may be employed.

Also, as described above, with the present embodiment, the controller 2100 accepts instructions of the operator relating to whether information which the operator can view or information which such a device can interpret is described in an instruction, through the above-mentioned user interface. Subsequently, the controller 2100 controls generation of an instruction by the above-mentioned instruction generating unit such that information relating to the post-processing thereof can be described in the instruction with the form corresponding to the instructions thereof of the operator. Such an arrangement may be employed, or another arrangement may be employed.

For example, let us say that the offline finisher 104 does not include the above-mentioned bar-code reader. Subsequently, this information is registered by the operator in the storage device 2102 as registration information which is the device configuration information of the offline finisher 104. On the other hand, let us say that the nearline finisher 103 includes the above-mentioned bar-code reader. Subsequently, this information is registered by the operator in the storage device 2102 as registration information which is the device configuration information of the nearline finisher 103. Alternatively, the controller 2100 automatically obtains the information from the nearline finisher 103 via the network to register this in the storage device 2102.

Subsequently, let us say that the controller 2100 has determined that the finisher for subjecting printed material of the job to be processed to post-processing is the offline finisher 104 including no bar-code reader by referencing the processing conditions of the job thereof. At this time, the controller 2100 reads out and references the device configuration information of the offline finisher 104 from the storage device 2102. In this case, when generating the instruction of this job, the controller 2100 performs control based on such information so as to automatically generate an instruction with the form shown in FIG. 5.

On the other hand, let us say that the controller 2100 has determined that the finisher for subjecting printed material of the job to be processed to post-processing is the nearline finisher 103 including the bar-code reader by referencing the processing conditions of the job thereof. At this time, the controller 2100 reads out and references the device configuration information of the nearline finisher 103 from the storage device 2102. In this case, when generating the instruction of this job, the controller 2100 performs control based on such information so as to automatically generate an instruction with the form shown in FIG. 15.

Thus, an arrangement may be made wherein, whether information which the operator can view or information which a device can interpret, is described in an instruction can be automatically determined based on the information of the post-processing for subjecting printed material to be generated by the printer unit 2200 to post-processing.

As described above, the printing system according to the present embodiment is configured so as to determine the expression form of information relating to post-processing to be described in an instruction automatically or manually, but the present invention is not restricted to this. For example, an arrangement including any one of these may be employed. In either case, it is desirable to apply the following arrangement as with the printing system according to the present embodiment.

For example, let us say that the job to be processed by the image forming apparatus 102 is an offline job requiring post-processing by the offline finisher including neither bar-code reader nor a function for reading information described in an instruction. In the case of determination corresponding to this case being made, when generating an instruction of the job along with generation of printed material of the job, the controller 2100 performs control so as to describe information which the operator can view in the instruction as information relating to the post-processing of the job.

On the other hand, let us say that the job to be processed by the image forming apparatus 102 is a nearline job requiring post-processing by the nearline finisher including the bar-code reader or the like and a function for reading information described in an instruction. In the case of determination corresponding to this case being made, when generating an instruction of the job along with generation of printed material of the job, the controller 2100 performs control so as to describe information which the nearline finisher can read and interpret in the instruction as information relating to the post-processing of the job.

Thus, the above-mentioned advantage can be obtained, and also there can be further improved working efficiency relating to post-processing at the job after printed material has been generated by the image forming apparatus 102.

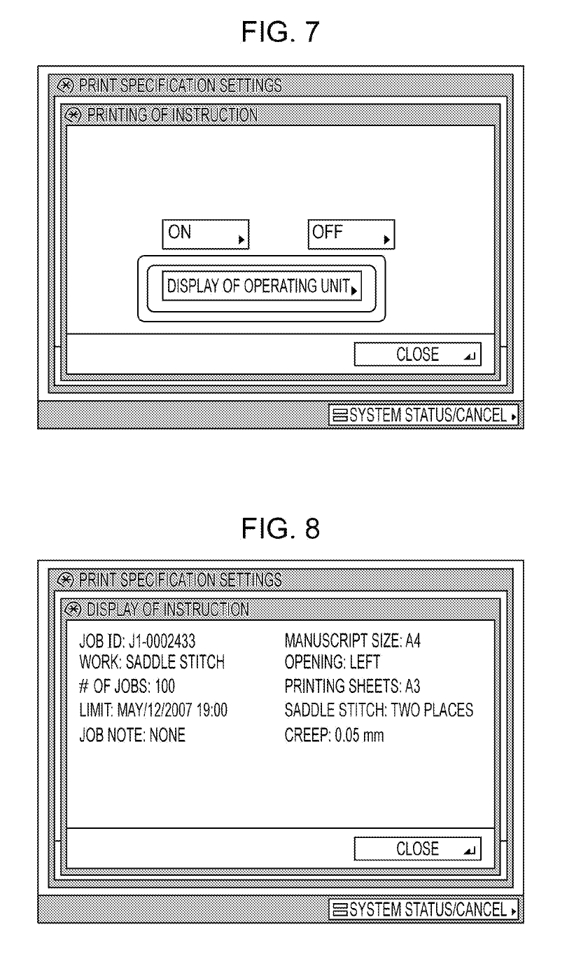

Note that, as described above, the printing system according to the present embodiment includes an arrangement to which a display unit serving as an instruction generating unit is applied, and the user interfaces such as the operating unit 2104, the monitor of the PC 101, and so forth are specific examples serving as the display unit. Accordingly, generating an instruction means that a display material corresponding to an instruction is displayed by such a display unit. Later-described user interface screens shown in FIGS. 7 and 8, and arrangement relating to S908 shown in FIG. 9 are specific examples of this. However, the application range of the present embodiment is not restricted to this.

For example, as described above, the printing system according to the present embodiment includes an arrangement to which a printing unit is applied as an instruction generating unit, and the printer unit 2200 is a specific example serving as this unit. Accordingly, generating to an instruction means that printed material corresponding to an instruction is generated by such a printing unit.

Thus, any of an arrangement employing a display unit as an instruction generating unit, an arrangement employing a printing unit, or an arrangement employing both as with the printing system according to the present embodiment, may be employed. In the case of employing a printing unit as an instruction generating unit, it is desirable to further include a function such as shown in the following.

For example, when printing an instruction along with printing of the body of a job to be processed at the printer unit 2200, the controller 2100 controls a discharge method of printed material corresponding to the instruction thereof. For example, as a later-described specific example, with the present embodiment, the controller 2100 performs control so as to determine based on the instructions of the operator from the user interface whether printed material corresponding to the instruction is output with face up or with face down.

Note that the term “output with face up” means to perform processing wherein, for example, in a state in which the first face sides of recording sheets where the odd-numbered of pages of images are printed are faced up, the recording sheets are stacked in a discharge unit, and also to perform discharge processing necessary for that processing. The term “output with face down” means to perform processing wherein in a state in which the first face sides of recording sheets are faced down, the recording sheets are stacked in the discharge unit, and also to perform discharge processing necessary for that processing.

Also, such as a later-described specific example, the printing system according to the present embodiment includes an arrangement wherein the operator himself/herself can select whether to output an instruction with face up or with face down. This is equivalent to an arrangement wherein the discharge face of an instruction is specified manually. Also, the printing system according to the present embodiment also includes an arrangement wherein whether to output an instruction with face down or with face up can be automatically determined by the controller 2100 so as to match the discharge state (discharge face) of the body of the job thereof. This is equivalent to an arrangement wherein the discharge face of an instruction is determined automatically. As with the printing system according to the present embodiment, both of these arrangements may be included, or only any one thereof may be included, but it is desirable to provide at least the following arrangement.

For example, let us say that the controller 2100 controls the printer unit 2200 to output printed material to be subjected to post-processing wherein information is described in an instruction (i.e., the body of a job requiring generation of an instruction), with face down. Even in this case, when generating the instruction along with generation of the printed material, the controller 2100 controls the printer unit 2200 to output the printed material corresponding to the instruction thereof with face up.

Note that the controller 2100 performs control so as to output the instruction of the job with face up even in the case of outputting the body of the job with face up.

Thus, with the present embodiment, the controller 2100 performs control so as to output the instruction of the job with face up regardless of whether the discharge state (discharge face) of the body of a job to be processed is output with face up or output with face down. Thus, trouble wherein an instruction is output with face down improperly, which makes it difficult for the operator to determine the presence of the instruction, can be suppressed. Thus, an advantage can be obtained wherein the above-mentioned advantage can be further improved.

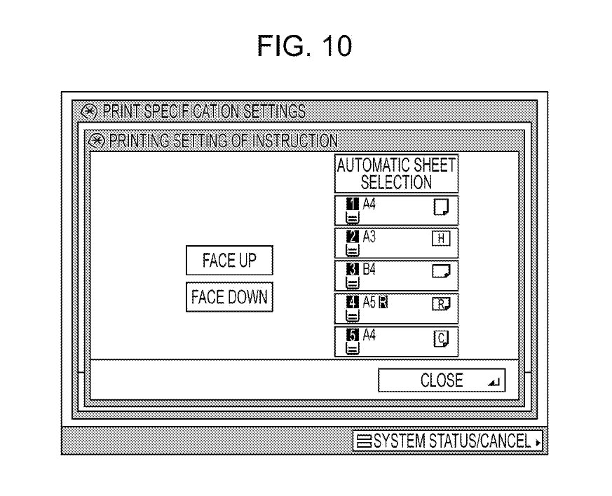

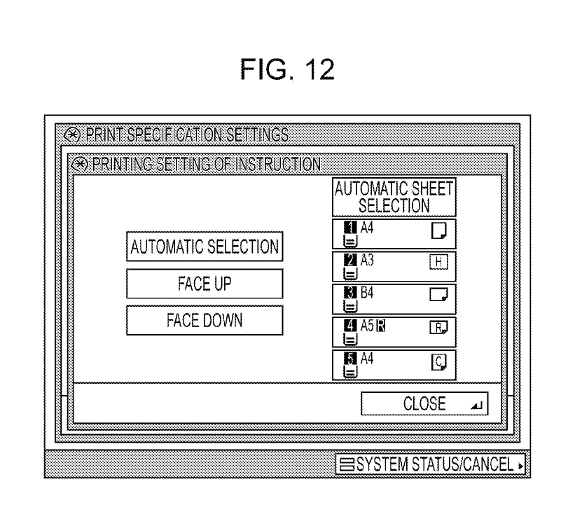

As described above, including an arrangement for controlling the discharge face of an instruction enables an advantage to be obtained wherein the above-mentioned advantage can be further improved. Note that an arrangement employing a later-described user interface shown in FIG. 10, user interface shown in FIG. 12, or the like is a specific example of the arrangement. Also, it is also desirable to include the following arrangement in addition to such an arrangement.

For example, in a case wherein an instruction of the job is generated by the printer unit 2200 along with generation of printed material of a job to be processed, the controller 2100 performs control for selecting a printing medium employed as printed material corresponding to the instruction thereof from the selection candidates of multiple recording media.

As this arrangement, with the present embodiment, the controller 2100 controls the printer unit 2200 to generate printed material corresponding to the instruction thereof employing a recording medium of a type/and or size based on the instructions of the operator from the user interface. An arrangement employing a later-described user interface shown in FIG. 10, user interface shown in FIG. 12, or the like is a specific example of the arrangement. Note that the printing system according to the present embodiment provides selection candidates available as an instruction to the operator like those user interfaces, employs the printing medium candidate selected by the operator as an instruction, and makes the above-mentioned information relating to post-processing print on the printing medium thereof. It is desirable to include an arrangement such as the present embodiment, but the present invention is not restricted to this.

Also, as with such an arrangement, the printing system according to the present embodiment includes not only an arrangement wherein the operator can select a printing medium to be employed as an instruction manually, but also an arrangement wherein the apparatus can select a recording medium to be employed as an instruction automatically.

For example, as this arrangement, the controller 2100 controls the printer unit 2200 to generate printed material corresponding to the instruction using a recording medium of a type/and or size based on the type and/or size of printed material to be subjected to post-processing, wherein information is described in an instruction. Note that, as a later-described specific example, the printing system according to the present embodiment includes the following arrangement. That is to say, in a case wherein the operator instructs automatic sheet selection of an instruction using an “automatic sheet selection” key provided at the user interface shown in FIG. 10 or 12, the controller 2100 performs control so as to execute the operation. Note that in FIGS. 10 and 12, the letters H, R, and C represent “Heavy”, “Recycled”, and “Color”, respectively, indicating the type of paper.

As described above, the printing system according to the present embodiment includes arrangements wherein various types of control relating to generation of an instruction can be executed, but may include all of these, or may include only any one thereof. For example, any kind of arrangement can be employed as long as at least one of the above-mentioned advantages can be obtained from the arrangement thereof.

Also, with the above-mentioned various types of arrangements and later-described specific examples, an arrangement is employed wherein the controller 2100 included in the image forming apparatus including the printer unit 2200 serves as a control unit, but the present invention is not restricted to this.

For example, various types of control relating to generation of an instruction described with present embodiment may be an arrangement realized by a CPU included in an external device capable of data communication with the image forming apparatus 102. Note that the PC 101 and nearline finisher 103 are equivalent to an example of this external device. Thus, the printing system according to the present embodiment is configured so as to be applied to an arrangement wherein a control unit is included in an external device which is different from the image forming apparatus 102.

Next, description will be made in order specific examples of control relating to generation of an instruction according to the above-mentioned present embodiment. Note that the arrangements other than the arrangements described below with reference to a specific example are all the same as the above-mentioned arrangements, so description thereof will be omitted.

Also, with the following specific examples, an arrangement is exemplified wherein the controller 2100 controls the operating unit 2104 to display various types of user interface screens of FIGS. 3, 4, 7, 8, 10, and 12, but the present invention is not restricted to this. For example, as described above, an arrangement may be employed wherein screens equivalent to those screens can be provided with the user interface of an external device such as the PC 101.

Also, with the following specific examples, the CPU of the controller 2100 reads out and executes a computer-executable program for executing the processing in the respective flowcharts of FIGS. 6, 9, 11, 13, and 14 from the internal memory of the image forming apparatus 102. Thus, such processing is executed. Such an arrangement will be exemplified, but the present invention is not restricted to this. For example, as described above, an arrangement may be employed wherein such processing is executed by the CPU of an external device such as the PC 101.

### SPECIFIC EXAMPLE 1

FIG. 3 is a screen displayed on the operating unit 2104 which allows the user to set print specifications, and particularly illustrates a portion relating to printing of an instruction.

FIG. 4 is a screen to be displayed on the operating unit 2104 when pressing a print button of an instruction in FIG. 3, and is a screen which allows the user to set whether to perform printing of an instruction.

FIG. 5 is an example of an instruction printed by the image forming apparatus 102 according to the arrangement of each embodiment described below. How to use this instruction will be described below.

For example, the operator visually confirms the content of the instruction shown in FIG. 5, whereby the operator understands the content of instructions of post-processing regarding printed material of a job to be processed in accordance with this instruction. With the example shown in FIG. 5, text information is printed on the instruction such that the operator can view the content of specific instructions thereof so as to subject printed material of the job to saddle-stitch binding. The operator takes out the printed material of this job from the discharge unit of the image forming apparatus 102 in accordance with the content of instructions of this instruction, and carries the printed material to a place where the post-processing apparatus determined by the content of instructions of this instruction is installed. For example, the operator carries the printed material of this job to the offline finisher 104. Subsequently, the operator sets post-processing conditions based on the content of instructions described in this instruction at the operating unit of the offline finisher 104 for this job. Thus, the offline finisher 104 subjects the printed material of this job to saddle-stitch binding, the processing necessary for the job is completed, and the final product is generated.

Next, a printing method of printed material body and instruction will be described with reference to the flowchart shown in FIG. 6.

First, the present processing is started in response to the power-on operation of the image forming apparatus 102 (step S601). Subsequently, a job is input from a job input source such as the client PC 101 or the like in response to the instructions from the user, whereby the controller 2100 receives the job to be processed with this printing system (step S602). Next, the controller 2100 determines whether or not this job is a job represented with a job ticket such as JDF or the like (step S603). If this job is not a job represented with a job ticket such as JDF or the like, as the processing of the job the controller 2100 prohibits printing of an instruction along with printing of the body, and controls the printer unit 2200 to print only the body (step S607). Thus, printing of only the body means that no instruction is printed, and printed material to be subjected to post-processing is generated, and the print data of the job is printed on printing sheets serving as this printed material. In the case of a job represented with a job ticket such as JDF or the like, the controller 2100 performs control in accordance with the setting in FIG. 4 of the user. For example, in the case of the user setting “OFF” for disabling printing of an instruction (“OFF” in step S604), the controller 2100 controls the printer unit 2200 to print only the body of this job (step S607).

In the case of the user setting “ON” for enabling printing of an instruction (“ON” in step S604), the controller 2100 interprets job control information such as JDF or the like (also referred to as “job ticket information”) packaged in this job (step S605). As a result of interpretation of the job control information, in the case of determining that there is no post-processing (NO in step S606), the controller 2100 performs the next control. As the processing of this job the controller 2100 performs control so as to print only the body without printing an instruction along with printing of the body (step S607). That is to say, as the processing of this job the controller 2100 prohibits generation of an instruction for this job along with printing of the body (generation of printed material). On the other hand, in the case of determining that there is post-processing (YES in step S606), the processing proceeds to step S608, where the controller 2100 performs the next control. The controller 2100 generates an instruction (permits generation of an instruction) for this job along with printing of the body (generation of printed material) as the processing of this job.

For example, in step S608, the controller 2100 controls the printer unit 2200 to execute printing of the printing data of the job (printing of body) packaged with the above-mentioned job ticket information for this JDF job. Further, the controller 2100 controls the printer unit 2200 to generate an instruction in which information relating to post-processing defined with the XML of this job is described along with printing of this body. For example, the controller 2100 controls the printer unit 2200 to print information relating to the post-processing to be performed on printed material where printing of this body is performed as to a printing medium corresponding to the instruction based on the above-mentioned job ticket information of this job.

Thus, the user can output the body and instruction at the same time.

### SPECIFIC EXAMPLE 2

Now, description will be made regarding an arrangement wherein display output of an instruction is performed without performing printing of an instruction as a method for generating an instruction.

FIG. 7 is a screen to be displayed on the operating unit 2104 at the time of pressing the print button of an instruction in FIG. 3, and is a screen allowing the user to select whether to print an instruction, whether to display an instruction on the operating unit, or whether to perform nothing.

FIG. 8 is an example of an instruction to be displayed on the operating unit 2104.

Next, a printing method of printed material body and instruction will be described with reference to the flowchart shown in FIG. 9.

First, the present processing is started in response to the power-on operation of the image forming apparatus 102 (step S901), a job is input from the client PC 101 or the like by the operations from the user, whereby the controller 2100 receives the job to be processed (step S902). Next, the controller 2100 determines whether or not this job is a job represented with a job ticket such as JDF or the like (step S903). If this job is not a job represented with a job ticket such as JDF or the like, the controller 2100 controls the printer unit 2200 to print only the body (step S907). If this job is a job represented with a job ticket such as JDF or the like, the controller 2100 performs control in accordance with the setting in FIG. 7 of the user. For example, in the case of the user setting “OFF” for disabling printing of an instruction (“OFF” in step S904), the controller 2100 controls the printer unit 2200 to print only the body (step S907).

In the case of the user setting “DISPLAY OF OPERATING UNIT” for enabling display of an instruction to the operating unit (“ON” in step S904), the controller 2100 interprets job control information such as JDF or the like for this job (step S905). As a result of interpretation of the job control information, in the case of determining that there is no post-processing (NO in step S906), the controller 2100 does not perform output of an instruction to the operating unit (step S907). That is to say, as the processing of this job the controller 2100 prohibits generation of an instruction for this job along with printing of the body (generation of printed material). On the other hand, in the case of determining that there is post-processing (YES in step S906), the processing proceeds to step S908, where as the processing of this job the controller 2100 permits generation of an instruction for this job along with printing of the body (generation of printed material).

For example, in step S908, the controller 2100 controls the printer unit 2200 to execute printing of the printing data of the job (printing of body) packaged with the above-mentioned job ticket information for this JDF job. Further, the controller 2100 controls the operating unit 2104 to generate an instruction in which information relating to post-processing defined with the XML of this job is described along with printing of this body. Note that as this operating unit the user interface accessed by the user of this job, such as the PC 101, mobile terminal, or the like may be employed as described above. Also, a specific example for generating an instruction using the operating unit is that information relating to post-processing to be performed on printed material where printing of this body is performed is displayed and output by the operating unit thereof based on the above-mentioned job ticket information of this job. Alternatively, an instruction having that same format as the printing results of an instruction to be printed actually is subjected to preview display. Further, when performing display of this instruction, the preview display of the body of the job thereof may also be executed. Such a technique may be employed.

Thus, the present invention can be applied to a method other than printing, which realizes generation of an instruction.

Note that in the case of displaying an instruction, as described above, an arrangement may be made wherein an instruction can be displayed with the same format as the format to be printed actually at the printer unit 2200 such as shown in FIG. 5 or 15.

For example, in this case, the controller 2100 controls a display unit serving as an instruction generating unit to display the preview image of the instruction of the job thereof along with the body being printed by the printer unit 2200.

Thus, the same output results can be obtained even in the case of printing out an instruction and in the case of displaying an instruction.

Also, in the case of such an arrangement, it is desirable to further include an arrangement wherein a display unit included in a mobile terminal which can be carried by the operator serves as an instruction generating unit. In the case of displaying an instruction with a bar code such as FIG. 15, the controller 2100 controls the display unit to display the bar code thereof as well through an unshown wireless communication unit. Subsequently, the controller 2100 controls the bar-code reader provided in the above-mentioned finisher to read the bar code displayed on this terminal. Thus, the finisher is instructed with the instruction on the post-processing as to the body of the job to be processed. Subsequently, the finisher is operated so as to subject the body thereof to the desired post-processing. Thus, an arrangement is made wherein the same processing as described above can be performed even without generating an instruction with paper, which may be included in an embodiment of the present invention.

### SPECIFIC EXAMPLE 3

Now, an arrangement will be described wherein a printing setting is performed at the time of printing of an instruction, the discharge faces are specified, and a sheet different from the body is employed, whereby, even in a case in which multiple instructions are stacked, the instructions can be distinguished.

FIG. 10 is an example of a printing setting screen to be displayed subsequently at the time of printing of an instruction being set to “ON” in FIG. 4.

Next, a printing method of printed material body and instruction will be described with reference to the flowchart shown in FIG. 11.

First, the present processing is started in response to the power-on operation of the image forming apparatus 102 (step S1101), a job is input from the client PC 101 or the like, whereby the controller 2100 receives the job to be processed (step S1102). Next, the controller 2100 determines whether or not this job is a job represented with a job ticket such as JDF or the like (step S1103). If this job is not a job represented with a job ticket such as JDF or the like, the controller 2100 performs control so as to print only the body (step S1107). If this job is a job represented with a job ticket such as JDF or the like, the controller 2100 performs control in accordance with the setting in FIG. 7 of the user. For example, in the case of the user setting “OFF” for disabling printing of an instruction (“OFF” in step S1104), the controller 2100 controls the printer unit 2200 to print only the body (step S1107).

In the case of the user setting “ON” for enabling printing of an instruction (“ON” in step S1104), the controller 2100 interprets job control information such as JDF or the like (step S1105). As a result of interpretation of the job control information, in the case of determining that there is no post-processing (NO in step S1106), the processing proceeds to step S1107, where the controller 2100 prohibits generation of an instruction along with printing of the body, and controls the printer unit 2200 to execute printing of the body alone. On the other hand, in the case of determining that there is post-processing (YES in step S1106), the processing proceeds to step S1108, where the controller 2100 permits generation of an instruction along with printing of the body at this job.

In step S1108, the controller 2100 controls the printer unit 2200 to execute feeding unit selection processing such that a printing medium to be employed as an instruction is fed from the feeding unit specified by the user from multiple selection candidates as the printing setting of an instruction. Subsequently, further, after printing the above-mentioned information on the printing medium corresponding to this instruction, the controller 2100 performs control so as to discharge this printing medium to the discharge unit with the discharge face (face up or face down) specified by the user as the printing setting of the instruction. The controller 2100 also controls the printer unit 2200 to execute the processing relating to such discharge face. Thus, in step S1108, as the processing of this job the controller 2100 performs control so as to perform printing of an instruction in accordance with the printing setting specified through the above-mentioned user interface by the user as the processing conditions relating to an instruction along with printing of the body.

Thus, the user can perform printing of an instruction using a desired discharge face and desired sheet, and accordingly, for example, can output the instruction with face up regardless of the specification of the discharge face of the body. The instruction can be readily confirmed, and can be readily found by outputting the instruction with a greater sheet size than the size of the body.

### SPECIFIC EXAMPLE 4

Now, an arrangement will be described wherein the specification of the discharge face is automatically switched with the discharge specification of body at the time of printing of an instruction, whereby the instruction can readily be distinguished.

FIG. 12 is an example of a printing setting screen to be displayed subsequently at the time of printing of an instruction being set to “ON” in FIG. 4.

Next, a printing method of printed material body and instruction will be described with reference to the flowchart shown in FIG. 13.

First, the present processing is started in response to with the power-on operation of the image forming apparatus 102 (step S1301), a job is input from the client PC 101 or the like, whereby the controller 2100 receives the job to be processed (step S1302). Next, the controller 2100 determines whether or not this job is a job represented with a job ticket such as JDF or the like (step S1303). If this job is not a job represented with a job ticket such as JDF or the like, the controller 2100 controls the printer unit 2200 to print only the body (step S1307). If this job is a job represented with a job ticket such as JDF or the like, the controller 2100 performs control in accordance with the setting in FIG. 7 of the user. For example, in the case of the user setting “OFF” for disabling printing of an instruction (“OFF” in step S1304), the controller 2100 prohibits generation of an instruction as the processing of the job, and controls the printer unit 2200 to print only the body (step S1307).

In the case of the user setting “ON” for enabling printing of an instruction (“ON” in step S1304), the controller 2100 interprets job control information such as JDF or the like (step S1305). As a result of interpretation of the job control information, in the case of determining that there is no post-processing as to the printed material of this job (NO in step S1306), the controller 2100 prohibits generation of an instruction as the processing of the job, and controls the printer unit 2200 to execute printing of the body alone (step S1307). On the other hand, in the case of determining that there is post-processing as to the printed material serving as the body of this job (YES in step S1306), the controller 2100 confirms the printing setting set by the user through the user interface as to the body of this job. Subsequently, based on the result thereof the controller 2100 confirms whether or not the setting of the discharge face as to the body is face down (step S1308). If the body is face down, when printing the instruction along with printing of the body as the processing of the job, the controller 2100 controls the printer unit 2200 to output the instruction thereof with face up (step S1309). On the other hand, in the case of outputting the printed material of this body with face up, the controller 2100 controls the printer unit 2200 to output the instruction of this job with face down (step S1310). Thus, the body and instruction are output such that the discharge faces of both are reversed, whereby these printed materials can be readily distinguished when the operator takes out these from printed materials loaded in the discharge destination, the existence thereof can be brought into prominence, facilitating handling thereof.

Thus, the user can output an instruction with a different discharge face from the discharge face of the body, and can readily confirm instructions at a post-processing process.

### SPECIFIC EXAMPLE 5

An arrangement will be described here wherein when switching to an alternative post-processing apparatus depending on the running status of the post-processing apparatus for the post-processing described within a job ticket packaged in a JDF job such as JDF or the like, an instruction is output so as to be suitable for the alternative post-processing apparatus.

Though an arrangement has been made in FIG. 1 wherein the image forming apparatus 102 receives a job ticket for performing output of printed material and work using the post-processing apparatus 104 from the client PC 101, let us assume a case wherein the post-processing apparatus 104 is not working for some reason. In this case, when replacing the post-processing apparatus 104 with the post-processing apparatus 103 capable of executing similar post-processing, the present embodiment enables an instruction suitable for the alternate post-processing apparatus 103 to be output.

A method for outputting an instruction suitable for the alternate post-processing apparatus will be described with reference to the flowchart shown in FIG. 14.

First, upon the present processing being started (step S1401), a job is input from the client PC 101 or the like, whereby the controller 2100 receives the job to be processed (step S1402). Next, the controller 2100 determines whether or not this job is a job represented with a job ticket such as JDF or the like (step S1403). If this job is not a job represented with a job ticket such as JDF or the like, as the processing of this job the controller 2100 controls the printer unit 2200 to print only the body without generating an instruction along with printing of the body (step S1407). If this job is a job represented with a job ticket such as JDF or the like, the controller 2100 performs control in accordance with the setting in FIG. 7 of the user. For example, in the case of the user setting “OFF” for disabling printing of an instruction (“OFF” in step S1404), the processing proceeds to step S1407. In step S1407, as the processing of this job the controller 2100 controls the printer unit 2200 to print only the body without generating an instruction along with printing of the body (step S1407).

On the other hand, in the case of the user setting “ON” for enabling printing of an instruction (“ON” in step S1404), the controller 2100 interprets job control information included in this JDF job (step S1405). As a result of interpretation of the job control information, in the case of determining that this job requires no post-processing (NO in step S1406), the processing proceeds to step S1407. As the processing of this job the controller 2100 controls the printer unit 2200 to execute printing of the body alone without generating an instruction.

On the other hand, in the case of determining that this job requires post-processing based on the analysis results of the job ticket information of this JDF job, the controller 2100 advances the processing to step S1408, where the controller 2100 confirms whether or not a post-processing apparatus to be used at the time of the post-processing of this job is running.

In step S1408, the controller 2100 determines based on the above-mentioned JDF information analysis results whether this job has been scheduled so as to use which post-processing apparatus. Thus, for example, if determination is made that the post-processing apparatus thereof is the nearline finisher 103, the controller 2100 starts network communication with the nearline finisher 103. At this time, the controller 2100 transmits a status request of this apparatus through the network shown in FIG. 1, and receives the status information of the nearline finisher 103 as the reply of this. Note that in the case of the offline finisher 104, network communication cannot be performed. Accordingly, in this case, the current operation status of the offline post-processing apparatus thereof is input by the operator at the timing for performing determination of step S1408 through the user interface such as the operating unit 2104. Thus, in step S1408, the controller 2100 determines the current status of the post-processing apparatus. Also, in a case wherein the post-processing apparatus used in this JDF job is an inline finisher, exchange of data is performed through the signal destination within the printing system according to the present embodiment. Thus, the controller 2100 obtains the current status of this apparatus.

As described above, the processing performed in step S1408 is exemplified processing, and any arrangement may be made as long as the controller 2100 can confirm the operation status of the post-processing apparatus to be used at the JDF job.

Subsequently, in a case wherein determination is made according to the confirmation in step S1408 that the post-processing apparatus to be used at the JDF job is now available (running), the controller 2100 advances the processing to step S1412.

In step S1412, as the processing of this JDF job the controller 2100 controls the printer unit 2200 to execute printing of the body of this job. Along with this, further, the controller 2100 controls the printer unit 2200 to execute generation (printing) of an instruction such that information reflecting the information relating to the post-processing defined with the job ticket information of this JDF job without modification is described as is.

On the other hand, in a case wherein determination is made according to the confirmation in step S1408 that the post-processing apparatus to be used at the JDF job is now unavailable (not running), the controller 2100 advances the processing to step S1409.

In step S1409, the controller 2100 confirms whether or not there is another post-processing apparatus (alternate post-processing apparatus) which can execute the post-processing of this JDF job, and if determination is made that there is no alternate post-processing apparatus, the controller 2100 advances the processing to step S1412, where the controller 2100 performs the same processing as the above-mentioned processing.

On the other hand, if there is an alternate post-processing apparatus, the controller 2100 advances the processing to step S1410, where the controller 2100 confirms the current operation status of the apparatus thereof. Subsequently, if the alternate post-processing apparatus thereof is now unavailable (not running), the controller 2100 advances the processing to step S1412, where the controller 2100 performs the same processing as the above-mentioned processing. On the other hand, if the alternate post-processing apparatus thereof is now available (running), the controller 2100 advances the processing to step S1411. Note that when performing various types of confirmation and determination in steps S1409 and S1410, the information of each apparatus is confirmed with the same technique as the above-mentioned technique in step S1408.

In step S1411, as the processing of this JDF job the controller 2100 controls the printer unit 2200 to execute printing of the body, and also controls the printer unit 2200 to generate (print) an instruction in which information suitable for the current available alternate post-processing apparatus is described. Specifically, the controller 2100 performs the following control applicable to the alternate post-processing apparatus for executing the post-processing necessary for this JDF job. The controller 2100 performs control so as to generate instruction information not depending on part of information relating to the post-processing defined with the job ticket information of this JDF job. Thus, the controller 2100 generates instruction information of which part of the content is modified from the content of the instruction information generated in step S1412. Subsequently, the controller 2100 controls the printer unit 2200 to execute generation (printing) of an instruction in which information reflecting the modification results is described along with printing of the body of the job.

An instruction serving as printing results such as shown in FIG. 15 can be generated according to the processing in step S1411.

FIG. 15 is an example of an instruction printed in the case of being replaced with a post-processing apparatus to which a bar-code reader is connected. The instruction shown in FIG. 15 is an instruction in which information relating to post-processing is described with an expression form which can be read by a device, but this point has been described in detail prior to description of specific example 1, so description thereof will be omitted.

Note that FIG. 15 exemplifies, for example, an instruction for the printed material of a job to be subjected to saddle-stitch binding by the nearline finisher 103 including a bar-code reader. When generating this instruction along with printing of the body of the job by the printer unit 2200, the controller 2100 subjects the instruction to printing processing such as shown in FIG. 15.

As shown in FIG. 15, the controller 2100 performs control so as to print character information on the instruction whereby the operator can view the content of the specific instructions so as to subject the printed material of the job to saddle-stitch binding. The operator takes out the printed material (body) of this job from the discharge unit of the image forming apparatus 102 in accordance with the content of the instructions of this instruction, and carries the printed material to a place where the post-processing apparatus (nearline finisher 103) determined with the content of the instructions of this instruction is installed.

Also, as shown in FIG. 15, the controller 2100 performs control so as to print information corresponding to information which the operator can distinguish, which can include such as QR code, on the instruction. The operator takes out this instruction together with the body from the discharge unit of the image forming apparatus 102. Subsequently, the controller 2100 controls the bar-code reader (not shown) of the nearline finisher 103 to read this instruction. The CPU of the nearline finisher 103 confirms this reading result, whereby the CPU can confirm that the printed material of this job is subjected to saddle-stitch binding. Thus, the CPU controls the nearline finisher 103 so as to subject the printed material of this job to saddle-stitch binding.

Thus, the processing necessary for the job is completed, thereby generating a final product.

### SPECIFIC EXAMPLE 6

Though an arrangement has been made wherein printing of the body is started after the status of the post-processing apparatus is determined in specific example 5, this can be true for an arrangement wherein the status of the post-processing apparatus is confirmed during printing of the body, and determination is made whether to alternate the post-processing apparatus. The printing system may be configured so as to include such an arrangement.

### SPECIFIC EXAMPLE 7

The controller 2100 also servers as a non-JDF job acceptance unit for accepting a non-JDF job employing no particular type of markup language such as XML as well as the above-mentioned JDF job. For example, a PDL job, which is provided by the maker of the image forming apparatus 102 uniquely, as an input target from the unique printer driver of the maker which can be installed in the PC 101 or the like is a specific example of this non-JDF job. Also, a copy job wherein printing data is input from an original reading device included in the image forming apparatus 102 itself though the user's instructions from the operating unit 2104, a facsimile job serving as facsimile reception target, and so forth are also specific examples of this non-JDF job. Also, a store job wherein data serving as a printing target is input a predetermined storing unit such as an unshown detachable removable medium in the storage device 2102 to which a hard disk or the like is applicable and/or image forming apparatus 102 is also a specific example of this non-JDF job.

Now, let us say that with a series of processing shown in FIG. 6 described above, the job of which the printing execution request has been accepted in step S602 is such a non-JDF job. In this case, the controller 2100 advances the processing from step S603 to step S607, where the controller 2100 performs the above-mentioned processing in step S607 for this non-JDF job.

Similarly, let us say that with a series of processing shown in FIG. 9 described above, the job of which the printing execution request has been accepted in step S902 is such a non-JDF job. In this case, the controller 2100 advances the processing from step S903 to step S907, where the controller 2100 performs the above-mentioned processing in step S907 for this non-JDF job.

Similarly, in FIGS. 11, 13, and 14, if the job of which the printing execution request has been accepted is a non-JDF job, the controller 2100 performs NO determination at each case of steps S1103, S1303, and S1403. Subsequently, with each case, the controller 2100 performs the above-mentioned processing in steps S1107, S1307, and S1407 for this non-JDF job.

Thus, the image forming apparatus 102 according to the present embodiment is configured so as to receive the above-mentioned various types of effects without causing a problem wherein a new trouble occurs due to coexistence of a JDF job and non-JDF job while supporting a non-JDF job.

As described above, the present embodiment can provide various types of arrangement serving as the printing system adapted to generate an instruction adapted to handle information relating to post-processing to be performed on printed material. For example, there can be provided an arrangement dealing with a problem wherein an instruction is generated unnecessarily. Also, for example, there can be provided an arrangement dealing with a productivity problem wherein generation of printed material which should be performed originally is delayed since generation of an instruction is attempted improperly. Also, for example, there can be provided an arrangement dealing with a problem that can occur due to a cause wherein an instruction is generated separately from generation of printed material. Thus, there can be provided an arrangement that contributes to practical use of a product adapted to generate an instruction adapted to handle information relating to post-processing to be performed on printed material.

### [Supplementary Explanation]

The image forming apparatus 102 serving as the printing system with the present embodiment includes the above-mentioned specific examples 1 through 6, and multiple components corresponding to various types of control according to generation of an instruction described prior to these specific examples. However, the present invention is not restricted to this, as described above. For example, a printing apparatus and/or post-processing apparatus and/or printing system including at least one of the multiple components according to generation of an instruction are also encompassed in the present invention.

Also, with the above-mentioned arrangements, an arrangement has been exemplified wherein the controller 2100 serves as a control unit for controlling multiple determinations according to generation of an instruction, but the present invention is not restricted to this. For example, with the above-mentioned arrangements of the present embodiment, an arrangement may be made wherein any determination and/or control of multiple determinations and/or controls serving as targets to be executed by the controller 2100 is performed by another unit. Thus, for example, the present invention is applied to an arrangement wherein a device and/or system are controlled by one CPU, and also an arrangement wherein an apparatus and/or system are controlled by multiple CPUs collaborating.

Also, the present invention may be applied to an arrangement wherein the functions according to the above-mentioned embodiment are executed by a host computer through a program to be installed externally such as a web server or the like. Note that, in this case, an arrangement is made wherein data for displaying the same operating screen as the operating screen described with the present embodiment including the respective operating screens is installed externally, whereby the above-mentioned various types of user interface screens can be provided on the display unit of the host computer. In this case, the present invention is applied even in a case wherein an information group including a program is supplied from a recording medium such as CD-ROM, flash memory, floppy disk, or the like, or an external storage medium through a network to an output device.

Also, as described above, the present invention may be applied to a system made up of multiple apparatuses, or may be applied to a stand-alone apparatus.

Also, the present invention can also be achieved by supplying a software program for realizing the functions of the above-mentioned embodiment to a system or device directly or remotely, and reading out and executing the supplied program by the computer of the system or device thereof. In this case, the form of the program does not need to be a program as long as this includes program functions. Accordingly, in order to realize the function processing of the present invention using a computer, program code itself to be installed in the computer also realizes the present invention.

That is to say, computer program code itself for realizing the function processing of the present invention is also included in the scope of the invention. In this case, if program functions are included, any program form may be employed, such as object code, program executed by an interpreter, script data supplied to an OS (operating system), or the like. Various types can be employed as a computer-readable recording medium for supplying the program. Examples of this include magnetic disks such as floppy disks and hard disks, optical discs such as CD-ROM, CD-R, CD-RW, DVD (DVD-ROM, DVD-R), optical disks such MO, and other memory media such as magnetic tape, nonvolatile memory cards, ROM, and so on.

With regard to a program supply method, the program can be supplied by connecting to a homepage of the Internet using a browser of a client computer, and downloading the program from the homepage to a storage medium such as a hard disk or the like. In this case, a download target may be the computer program itself of the present invention or may be a file including compressed automatic installation functions. Also, the program code making up the program of the present invention is divided into multiple files, and the respective files are downloaded from a different homepage, whereby the program of the present invention can be supplied. That is to say, a www server for downloading program files for realizing the function processing of the present invention at a computer to multiple users is also encompassed in the claims of the present invention.

Also, an arrangement may be employed wherein the program of the present invention is encrypted, stored in a storage medium such as CD-ROM or the like, and distributed to users. In this case, a user who satisfies predetermined conditions is allowed to download key information for decrypting encryption from a homepage through the Internet, with the user using this key information to install the encrypted program in a computer in an executable format.

Also, the computer executes the read program, whereby the functions of the above-mentioned embodiment can be realized with an arrangement other than an arrangement wherein the functions of the above-mentioned embodiment are realized. For example, the OS or the like running on a computer may perform a part or all of the actual processing based on the instructions of the program thereof, and the functions of the above-mentioned embodiment can be realized with the processing thereof.

Further, the program read out from a storage medium may be written in memory included in an function expansion board inserted in a computer or function expansion unit connected to a computer. In this case, subsequently, the CPU or the like included in the function expansion board or function expansion unit thereof performs a part or all of the actual processing base on the instructions of the program, and the functions of the above-mentioned embodiment can be realized with the processing thereof.

Thus, the present invention is not restricted to the above-mentioned embodiments, various modifications (including an organic combination of the respective embodiments) can be made based on the essence of the present invention, and these are not excluded from the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2007-224556 filed Aug. 30, 2007, which is hereby incorporated by reference herein in its entirety.

1. A printing system comprising:
a generation unit adapted to generate an instruction, with the instruction being adapted to process information relating to post-processing to be performed on printed material generated by a printer; and
a controller adapted to control the printer to generate the printed material without generating the instruction by the generation unit in a case in which there is no need to generate the instruction;
wherein the controller is adapted to control the generation unit so as to generate the instruction along with the printed material being generated at the printer in a case in which there is a need to generate the instruction.

2. The printing system according to claim 1, wherein the controller is adapted to wait until the printer completes generation of the printed material, and control the generation unit so as to generate the instruction.

3. The printing system according to claim 1, wherein in a case in which settings of an operator for instructing a printing apparatus including the printer to generate an instruction have been performed, the controller is adapted to control the generation unit so as to generate the instruction along with the printer generating the printed material.

4. The printing system according to claim 1, wherein in a case in which settings of an operator for instructing a job requiring generation of printed material by the printer to generate an instruction have been performed, the controller is adapted to control the generation unit so as to generate the instruction along with the printer generating the printed material.

5. The printing system according to claim 1, wherein in a case in which a job requiring generation of printed material by the printer is a job of which the instruction content is defined with a particular file format, the controller is adapted to control the generation unit so as to generate an instruction for the job along with the printer generating the printed material of the job;
and wherein in a case in which a job requiring generation of printed material by the printer is not a job of which the instruction content is defined with the particular file format, the controller is adapted to control the printer to generate printed material of the job without an instruction for the job being generated by the generation unit.

6. The printing system according to claim 1, wherein in a case in which a job requiring generation of printed material by the printer is a job requiring post-processing by a post-processing apparatus including printed material reception unit adapted to receive the printed material without intervention of an operator, the controller is adapted to control the printer to generate printed material of the job without the generation unit generating an instruction for the job.

7. The printing system according to claim 1, wherein in a case in which a job requiring generation of printed material by the printer is a job not requiring material handling operation of the printed material by an operator before the printed material is subjected to post-processing, the controller is adapted to control the printer to generate printed material of the job without the generation unit generating an instruction for the job;
and wherein in a case in which the job is a job requiring material handling operation of the printed material, the controller is adapted to control the generation unit so as to generate an instruction for the job along with generation of printed material of the job.

8. The printing system according to claim 1, wherein in a case in which a job requiring generation of printed material by the printer is a job requiring post-processing by a post-processing apparatus excluding a printed material reception unit adapted to receive the printed material without intervention of an operator, and including a communication unit for performing data communication with another device, the controller is adapted to control a user interface such that the operator can select whether to generate an instruction for the job along with generation of printed material of the job through the interface.

9. The printing system according to claim 1, wherein, the controller is adapted to control the generation unit so as to generate, in a case in which a post-processing apparatus for subjecting printed material generated by the printer to post-processing is changed, an instruction in which information to which the content of the change thereof is reflected is described.

10. The printing system according to claim 1, wherein the controller is adapted to control the generation unit so as to generate an instruction in which information which can be viewed by an operator is described.

11. The printing system according to claim 1, wherein the controller is adapted to control the generation unit so as to generate an instruction, in which information which can be interpreted by a device requiring subjecting the printed material to post-processing, is described.

12. The printing system according to claim 1, wherein in accordance with the instructions of an operator from a user interface the controller is adapted to determine whether to describe information which can be viewed by the operator or information which can be interpreted by a device.

13. The printing system according to claim 1, wherein the controller is adapted to automatically determine whether to cause the printer to generate the instruction which can be viewed by an operator or to cause the printer to generate the instruction which can be interpreted by a device, based on information about a post-processing apparatus for subjecting the printed material to post-processing.

14. The printing system according to claim 1, wherein a display unit is adapted as the generation unit;
and wherein the display unit is configured so as to display a display material adapted as the instruction.

15. The printing system according to claim 1, wherein the printer is adapted as the generation unit;
and wherein the printer is configured so as to generate printed material adapted as the instruction.

16. The printing system according to claim 15, wherein based on the instructions of an operator from a user interface the controller is adapted to determine whether to output the printed material with face down or face up as the instruction.

17. The printing system according to claim 15, wherein even in a case wherein the printed material to be subjected the post-processing is output with face down, the controller is adapted to control the printer to output printed material adapted as the instruction with face up.

18. The printing system according to claim 15, wherein the controller is adapted to control the printer to generate printed material adapted as the instruction using a printed medium of a type and/or size based on the instructions of an operator from a user interface.

19. The printing system according to claim 15, wherein the controller is adapted to control the printer to generate printed material adapted as the instruction using a printed medium of a type and/or size based on the type and/or size of printed material to be subjected the post-processing.

20. The printing system according to claim 1, wherein a controller provided by a printing apparatus including the printer is adapted as the controller.

21. The printing system according to claim 1, wherein a controller provided by a device capable of data communication with a printing apparatus including the printer is adapted as the controller.

22. A printing apparatus configured so as to be applied to the printing system according to claim 1, comprising:
the printer;
the generation unit; and
the controller.

23. A controlling method adapted to a printing system configured to cause a generation unit to generate an instruction, with the instruction being adapted to handle information relating post-processing to be performed on printed material to be generated by a printer, the method comprising:
causing the printer to generate the printed material without generating the instruction by an instruction generating unit in a case in which there is no need to generate the instruction; and
causing the instruction generating unit to generate the instruction by the printer generating the printed material in a case in which there is a need to generate the instruction.

24. A computer-readable storage medium storing a program allowing a computer to execute the method according to claim 23.
